(19) United States
(12) Patent Application Publication
(10) Pub. No.: US 2016/0169122 A1
(43) Pub. Date: Jun. 16, 2016

(54) THROTTLE VALVE ASSEMBLY BLADE

(71) Applicants: Continental Automotive Systems, Inc., Auburn Hills, MI (US); GM Global Technology Operations LLC, Detroit, MI (US)

(72) Inventors: John Norman Stockbridge, Waterford, MI (US); Nathan Cowan, Chatham (CA); Dean G. Sorrell, Rochester Hills, MI (US)

(21) Appl. No.: 14/942,308

(22) Filed: Nov. 16, 2015

Related U.S. Application Data
(60) Provisional application No. 62/090,103, filed on Dec. 10, 2014.

(51) Int. Cl. F02D 9/10

(52) U.S. Cl. CPC F02D 9/1085; F02D 9/1065

(57) ABSTRACT

A throttle control assembly which includes a valve plate made of aluminum, where the valve plate has a brass coating to substantially reduce or eliminate the effects of thermal cycling, and the probability of the occurrence of micro-welding. In one embodiment, the brass coating is applied using an electroplating process.

### CROSS-REFERENCE TO RELATED APPLICATIONS

This application claims the benefit of U.S. Provisional Application No. 62/090,103 filed Dec. 10, 2014. The disclosure of the above application is incorporated herein by reference.

### FIELD OF THE INVENTION

The invention relates generally to a blade or plate that is part of a throttle assembly, where the plate has a coating to prevent the occurrence of micro-welds between the plate and the housing during operation.

### BACKGROUND OF THE INVENTION

Throttle control assemblies are generally known, and are used for controlling the amount of air flow into the engine during vehicle operation. These throttle control assemblies often include a plate, or blade, mounted to a shaft, which is rotated to control the amount of air flow through a housing. The housing includes an aperture, and the plate is disposed within the aperture. The material used for making the plate is typically of one of several different types of materials chosen. One of these materials commonly used is aluminum. However, a plate created using aluminum in these applications is susceptible to shifting position relative to the shaft during the life of the throttle control assembly due to thermal cycling. Furthermore, the use of aluminum may cause micro-welding to occur between the plate and the housing, affecting the operation of the plate. One way to overcome these issues is to use a brass plate, instead of aluminum, which is resistant to high temperatures. However, it is more difficult to manufacture a brass plate within the required manufacturing tolerances.

Accordingly, there exists a need for a throttle control assembly has a plate that is less susceptible to being affected by thermal cycling and reduces or eliminates the probability of micro-welding to occur, and is able to manufactured to precise tolerance specifications.

### SUMMARY OF THE INVENTION

The present invention is a throttle control assembly which includes a valve plate made of aluminum, where the valve plate has a coating to substantially reduce or eliminate the probability of the occurrence of micro-welding, and the effects of thermal cycling. In one embodiment, the coating is applied using an electroplating process. The coating may be different types of materials, such as brass, or nickel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a first perspective view of a throttle valve assembly, according to embodiments of the present invention;

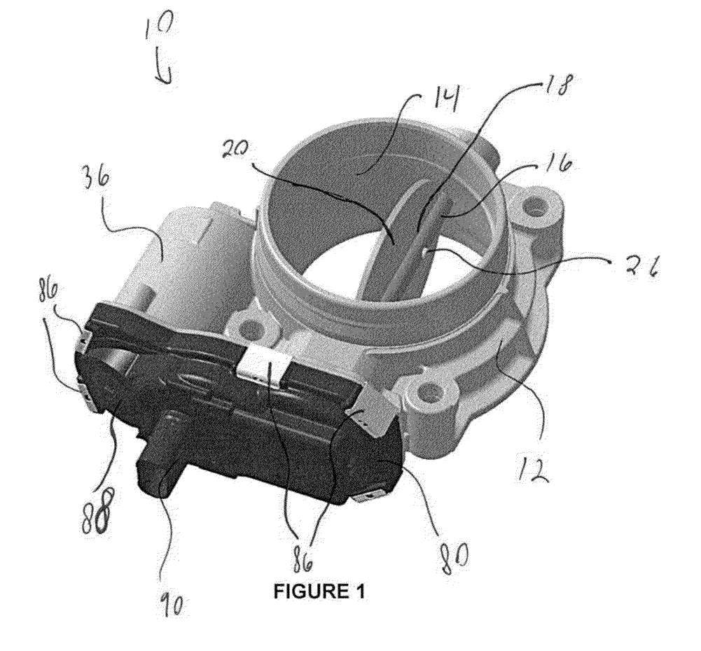

FIG. 2 is a second perspective view of a throttle valve assembly, according to embodiments of the present invention; and

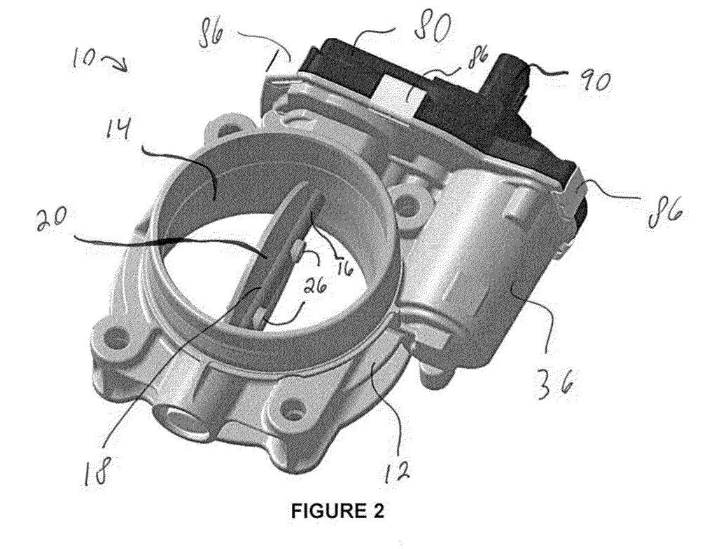

FIG. 3 is a top view of a plate which is part of a throttle valve assembly, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

A throttle control assembly according to the present invention is shown in the Figures generally at 10. The assembly 10 includes a housing 12, and formed as part of the housing 12 is a central port 14, through which air passes during operation of the assembly 10. Disposed in the central port 14 is a shaft 16, which is rotatable. The shaft 16 includes a slot 18, and disposed in the slot 18 is a valve member, which in this embodiment is a valve plate 20. The valve plate 20 includes two apertures, which are in alignment with two threaded apertures formed as part of the shaft 16. Connecting the plate 20 to the shaft 16 are two fasteners, which in this embodiment are threaded screws 26, that are inserted through the apertures of the plate 20 and the threaded apertures of the shaft 16, securing the valve plate 20 to the shaft 16.

The shaft 16 partially extends through the housing 12, such that part of the shaft 14 is disposed in the port 14. Also located in the aperture are needle bearings which support the shaft 16, and allow for the shaft 16 to rotate relative to the housing 12.

The housing 12 also includes a cavity, and the cavity is formed as part of the portion of the housing 12 indicated at 36. Disposed in the cavity is an actuator, which in this embodiment is an electric motor. Attached to the shaft of the motor is a first gear, or pinion gear, which is part of a gear train, having a plurality of gears, which transfers rotational force from the motor to the shaft 16. Connected to the housing 12 is a cover 80, and disposed between the cover 80 and the housing 12 is a seal which surrounds an outer lip formed as part of the housing 12. The gear train is adjacent the housing 12 and is concealed by the cover 80. The cover 80 is connected to the housing 12 using a plurality of clips 86. There is also a secondary cover 88, which is attached to the cover 80. Once the cover 80 is attached to the housing 12, the terminals for the motor can be viewed through an opening in the cover 80. Once it is determined that the terminals of the motor 38 are in contact with the terminals formed as part of the cover 80, the secondary cover 88 is attached to the cover 80.

The cover 80 also includes connectors 90 which are in electrical communication with the motor 38, such that the connectors 90, are able to be connected to a source of power. Integrally formed with the cover 80 is a lead frame which places the connectors 90 in electrical communication with a sensor.

In operation, a return spring biases the gear train, and therefore the shaft 16 and valve plate 20 towards a closed position, such that the central port 14 is substantially closed, or blocked completely, depending upon how the assembly 10 is configured. When a current is applied to the motor, the gears in the gear train are rotated. To rotate the valve plate 20, the force applied to the gear train by the return spring is overcome. The amount of rotation in the gear train is in proportion to the amount of current applied to the motor, which overcomes the force applied to the gear train by the return spring.

As the gears in the gear train are rotated, the shaft 16 is rotated as well, rotating the plate 20, and controlling the amount of air flow through the central port 14. The amount of rotation of the gear train is detected by the sensor, such that the valve plate 20 may be placed in a desired position.

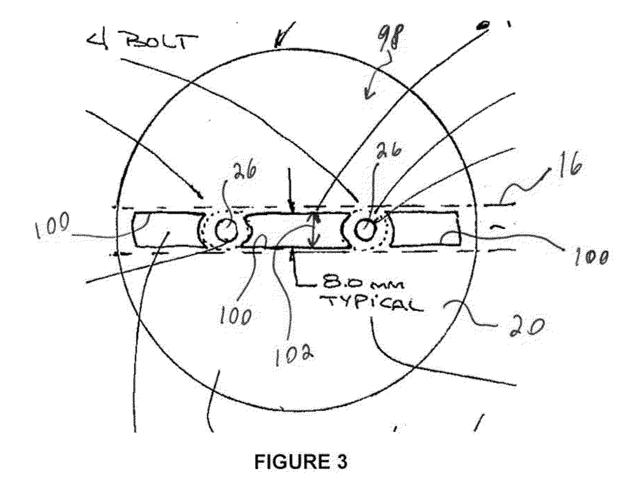

The plate 20 in this embodiment is an aluminum plate, which has a brass coating, shown generally at 98. The use of aluminum in manufacturing the plate 20 allows the plate 20 to be sized to tight manufacturing tolerances, and the brass coating 98 provides the advantage of minimizing the chances of the formation of micro-welds between the plate 20 and the port 14, and allows the plate 20 to be used in high-performance applications, either in applications such as the throttle control assembly 10, as described above, or in any other type of application requiring a valve plate. In one embodiment, the shaft 16 is about eight millimeters in diameter, but it is within the scope of the invention that other diameter dimensions may be used, such as, but not limited to diameters ranging from six millimeters to twelve millimeters and above in diameter. The plate 20 includes a plurality of apertures 100 which facilitate the plate 20 being able to deflect relative to the shaft 16 during thermal cycling without changing the location of the plate 20 relative to the shaft 16. The width 102 of each of the apertures 100 is about six millimeters, such that there is an overlap of about one millimeter (on each side of the apertures 100) between the apertures 100 and the shaft 16, as shown in FIG. 3. In one embodiment, the brass coating 98 is only applied to the outer diameter of the plate 20, and in another embodiment, the brass coating 98 is applied to the entire surface of the plate 20. The brass coating 98 may be applied to the plate 20 through the process of electroplating, or other processes as well. Furthermore, other types of coatings, instead of the brass coating 98, is applied to the plate 20 to make the plate 20 be suitable for other embodiments. These other types of coatings may be nickel coatings, or the like. In yet additional embodiments, certain types of surface modifications may be used, instead of the coating 98, such as etching or any other type of surface modification.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A throttle control assembly, comprising:
a housing;
a central port formed as part of the housing;
a shaft extending through the housing such that a portion of the shaft extends through the central port;
a valve member mounted on the shaft such that the valve member is movable with the central port;
an actuator connected to the housing; and
a coating applied to the valve member;
wherein the actuator selectively causes rotation of the shaft to change the valve member between an open position and a closed position, and the coating prevents the valve member from micro-welding to the central port.

2. The throttle control assembly of claim 1, further comprising a gear train having a plurality of gears, one of the plurality of gears connected to the actuator, another of the plurality of gears connected to the shaft, wherein actuator rotates the plurality of gears, causing rotation of the shaft, changing the valve member between the open position and the closed position.

3. The throttle control assembly of claim 2, further comprising a return spring operable for applying rotational force to the plurality of gears, biasing the gear train such that the shaft and valve member are biased towards the closed position.

4. The throttle control assembly of claim 1, wherein the valve member is a plate.

5. The throttle control assembly of claim 4, wherein the plate is made of aluminum.

6. The throttle control assembly of claim 4, wherein the coating is a brass coating.

7. The throttle control assembly of claim 4, wherein the coating is a nickel coating.

8. The throttle control assembly of claim 4, wherein the coating is applied to the outer diameter of the plate.

9. The throttle control assembly of claim 4, wherein the coating is applied to the entire surface of the plate.

10. The throttle control assembly of claim 4, further comprising at least one aperture formed as part of the plate.
